(19) United States
(12) Patent Application Publication
(10) Pub. No.: US 2023/0322419 A1
(43) Pub. Date: Oct. 12, 2023

(54) RADIATING COUPLING HEAT PIPE

(71) Applicant: Maxar Space LLC, Palo Alto, CA (US)

(72) Inventor: Jason Chiang, Fremont, CA (US)

(73) Assignee: Maxar Space LLC, Palo Alto, CA (US)

(21) Appl. No.: 17/718,050

(22) Filed: Apr. 11, 2022

(51) Int. Cl. B64G 1/50; F28D 15/02; B64G 1/10

(52) U.S. Cl. CPC B64G 1/503; F28D 15/0275; B64G 1/506; B64G 1/10

(57) ABSTRACT

An apparatus comprising a satellite includes a first radiator panel on a first side of a central body of the satellite and a second radiator panel on a second side of the central body is provided. The first radiator panel is thermally attached to the second radiator panel. A third side of the central body is positioned between the first side and the second side. A fourth side of the central body is positioned between the first side and the second side, opposing the third side. The first radiator panel is thermally attached to the second radiator panel by one or more coupling heat pipes, the coupling heat pipes exposed to an exterior environment of the satellite.

### BACKGROUND

The present disclosure relates to satellite technology.

Satellites are widely used for a variety of purposes including communication, location, and data gathering (e.g., directing sensors at the Earth including cameras, radar, laser, or other sensors). Different satellites may include different equipment according to the functions they are to fulfill. Satellites may be placed in orbit at different heights above the Earth and may be adapted for the location at which they are expected to operate. For example, Geostationary satellites occupy a geosynchronous equatorial orbit (GEO), at altitude above an orbital body and follow the direction of Earth's rotation. In order to fulfill their functions, satellites may carry equipment which generates significant which may be problematic. If heat is not adequately managed, temperature of satellite components may rise to unacceptable levels, which may affect operation. Managing heat in space is generally more challenging than other environments (e.g., on or under land, in air, or in water). Designing a satellite to accommodate heat generating components it may generate while minimizing costs and resources such as mass and size is a challenging task.

When orbiting a body, a satellite may have a main body with North (N), South (S), East (E), and West (W) sides, labeled according to the general direction toward which its normal vector is oriented when the satellite is on-orbit. Radiator panels may be disposed on one or more of the sides to dissipate heat from heat generating components in the satellite.

### BRIEF DESCRIPTION OF THE DRAWINGS

FIG. 1 is a block diagram describing one embodiment of a portion of a satellite communications system.

FIG. 2 is a block diagram depicting a satellite including a bus and payload.

FIG. 3 shows an example of a satellite including solar panels and antennas extending from a central body.

FIG. 4 shows an example of mounting of heat generating components in central body.

FIG. 5 shows an example of a central body having a cubic shape with six sides.

FIGS. 6A-6C illustrate embodiments of a radiator system.

FIGS. 7A-7C illustrates embodiments of the radiator systems of FIGS. 7A-7C within a central body of a satellite.

FIGS. 8-10 illustrate examples of a satellite incorporating a thermal coupling structure.

FIG. 11 illustrates an alternative embodiment of a radiator system.

### DETAILED DESCRIPTION

Aspects of the technology may be applied to satellites used for various purposes. In many satellites, significant heat may be generated by electronic components which provide the intended functions of the satellite. Such heat-generating components may be attached to radiator panels in a manner that enables efficient heat transfer from heat-generating components to radiator panels from which it is radiated into space.

In order to reduce the impact of the incident solar load on satellites and increase the thermal dissipation capability of satellites, east and west radiators (relative to the direction of orbit about an orbital body) are thermally coupled together using a thermal coupling which is exposed to an exterior of a satellite. The radiators may share the thermal load with thermally connected north/south radiator panels, the thermal dissipation capability of the east and west radiator panels of the radiator system.

Aspects of the technology may be implemented in a single satellite or in multiple satellites (e.g., in a satellite communication system). A satellite communication system may include a single satellite or a constellation of geostationary or non-geostationary satellites orbiting the Earth, a plurality of gateways and a plurality of subscriber terminals (also referred to as terminals).

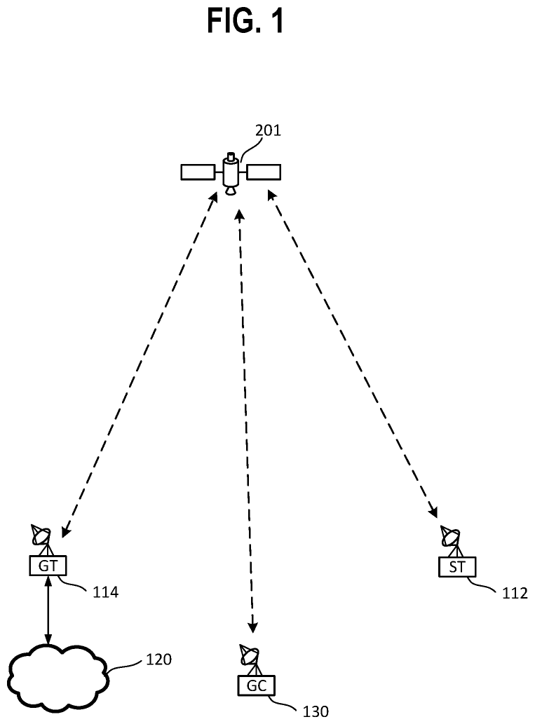

FIG. 1 is a block diagram depicting a portion of a satellite communications system that includes one or more satellites. FIG. 1 depicts satellite 201, which may be a geostationary satellite or a non-geostationary satellite. A geostationary satellite moves in a geosynchronous orbit (having a period of rotation synchronous with that of the Earth's rotation) in the plane of the Equator, so that it remains stationary in relation to a fixed point on the Earth's surface. This orbit is often achieved at an altitude of 22,300 miles (35,900 km) above the earth; however, other altitudes can also be used. A non-geostationary satellite is a satellite that is not a geostationary satellite and is not in an orbit that causes the satellite to remain stationary in relation to a fixed point on the Earth's surface. Examples of non-geostationary satellites include (but are not limited to) satellites in Low Earth Orbits (“LEO”), Medium Earth Orbits (“MEO”) or Highly Elliptical Orbits (“HEO”). Although FIG. 1 only shows one satellite, in some embodiments the system will include multiple satellites that are referred to as a constellation of satellites, which may communicate with each other.

The system of FIG. 1 includes satellite 201, subscriber terminal 112, gateway terminal 114, and ground control terminal 130. Subscriber terminal 112, gateway terminal 114, and ground control terminal 130 are examples of ground terminals. Spacecraft 110 is communicatively coupled by at least one wireless link to at least one gateway terminal 114 and by at least one wireless link to a plurality of subscriber terminals (e.g., subscriber terminal 112) via an antenna system. Gateway terminal 114 is connected to the Internet 20. The system allows satellite 201 to provide internet connectivity to a plurality of subscriber terminals (e.g., subscriber terminal 112) via gateway terminal 114. Ground control terminal 130 is used to monitor and control operations of satellite 201. Spacecraft can vary greatly in size, structure, usage, and power requirements, but when reference is made to a specific embodiment for the satellite 201, the example of a communication satellite will often be used in the following, although the techniques are more widely applicable, including other or additional payloads such as for an optical satellite.

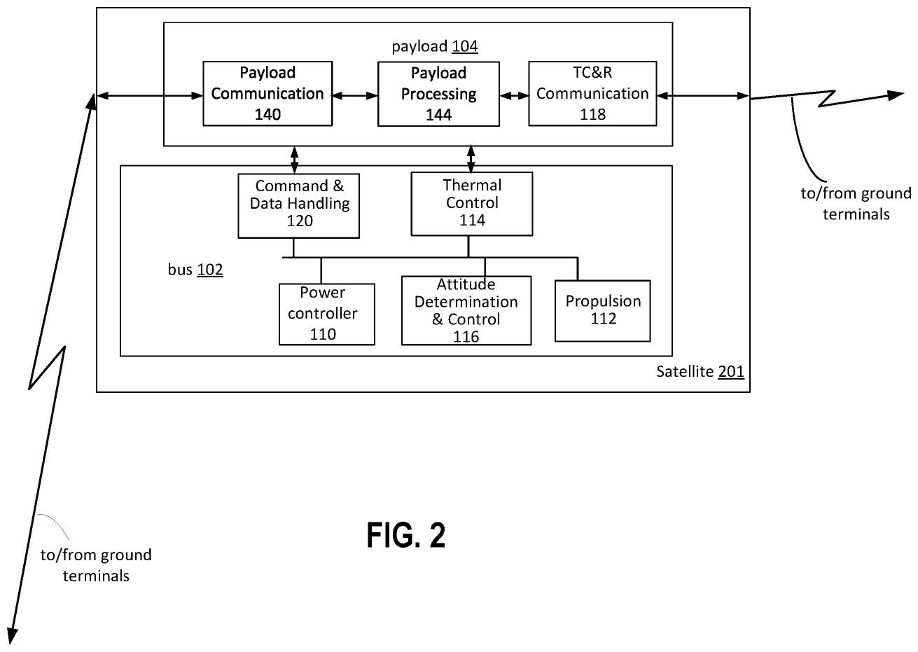

FIG. 2 is a block diagram of one embodiment of satellite 201 of FIG. 1. In one embodiment, satellite 201 includes a bus 102 and a payload 104 carried by bus 102. Some embodiments of satellite 201 may include more than one payload. The payload provides the functionality of the communication and/or processing systems described herein.

In general, bus 102 is the spacecraft that houses the payload. For example, the bus components include a power controller 110, which may contain solar panels and one or more batteries (not shown in FIG. 2) to provide power to other satellite components; propulsion 112; thermal control 114; attitude determination and control 116; telemetry command and data handling (T, C & R communication) 118; and command and data handling 120. Other equipment can also be included. Solar panels and batteries within the power controller 110, are used to provide power to satellite 201. Thrusters and propellent within propulsion 112 are used for changing the position or orientation of satellite 201 while in space. Attitude sensors within attitude determination & control 116 are used to determine the position and orientation of satellite 201. System processor(s) within control and data handling 120 is used to control and operate satellite 201. An operator on the ground can control satellite 201 by sending commands via T, C & R communication 118, and processing equipment 118 to be executed by control and data handling 120. Some embodiments include a Network Control Center that wirelessly communicates with T, C & R communication, and processing equipment 118 to send commands and control satellite 201. In one embodiment, control and data handling 120 and T, C & R communication, and processing equipment 118 are in communication with payload 104. In general, electronic components of bus 102 (e.g., processor 120, T, C & R communication, and processing equipment 118, payload 104, and power controller 110) generate heat (e.g., due to resistive heating effects) and will be maintained and controlled by the thermal control within acceptable temperature ranges. The technology described herein may be applied to any type of satellite in which the instruments, payload or any spacecraft hardware generates heat in space.

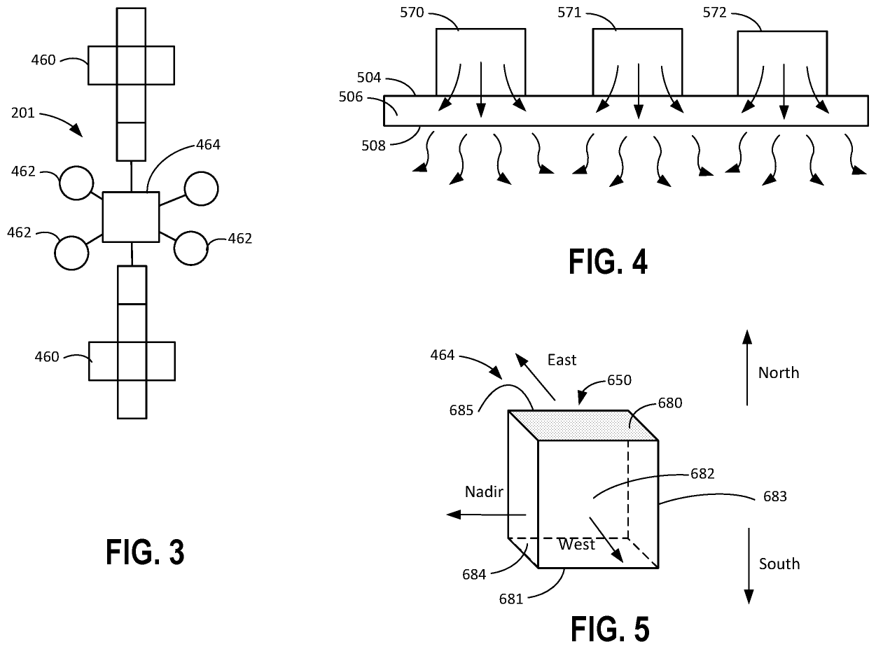

FIG. 3 illustrates an example of satellite 201 that includes solar panels 460 and antennas 462 extending from a central body 464. In general, satellite bus and payload components may be located together in such a central body. In some cases, a central body may include one or more radiator panels to radiate heat generated by heat-generating components.

FIG. 4 shows an example of mounting of heat generating components in central body 664 of satellite 201. Heat-generating components 570, 571, 572 are attached to a first surface 504 of a radiator panel 506 so that heat generated in heat-generating components 570-772 can easily flow into radiator panel 506, where it is dispersed laterally and can be radiated into space from a second surface 508 of radiator panel 506 (as illustrated by wavey arrows).

FIG. 5 shows an example of a central body 464 having a cubic shape with six sides 680-685 that includes a radiator panel on the north facing side 680 of central body 664. Each side 680-685 is labeled according to the general direction toward which its normal vector is oriented when the satellite is on-orbit about an orbital body. Ones of the six sides of the central body may be referred to as a first or North (N) side 680, a second or South (S) side 681, a third or East side (E) 685, and a fourth or West side (W) 682, all of which are disposed between, and orthogonal to, a fifth side or a forward side 684 (generally disposed in the nadir direction to an orbital body) and a sixth side or aft side 683 (generally disposed in the zenith direction relative to a body orbited by the satellite). Each of the sides may also be referred to as panels, side panels, sides, or surfaces. For example, an on-orbit satellite is generally oriented such that normal vectors drawn from the N panel and the S panel are in substantial alignment with the N-S axis of the Earth, with the N panel facing North and the S panel facing South, and such that the normal vectors drawn from the E panel and the W panel are in substantial alignment with the E-W direction of the Earth.

North side 680 and south side 681 may be suitable for radiating heat because they are generally not facing the sun so that any radiated heat from the sun hits them obliquely at a low angle and does not cause substantial heating. In an example, radiator panels are provided along surfaces of both north side 680 and south side 681. Other sides such as west side 682 or forward (nadir) 684 may be subject to radiated heat from the sun at angles close to ninety degrees at certain times. Typically, east 685 and west 682 facing sides of the satellite offer limited thermal dissipation capability due to the high incident solar load on those surfaces. In accordance with the technology, the east and west facing sides may be used to mount and dissipate the thermal load caused by heat generating components such as RF loads, feeds, switches, circulators, and multiplexers (OMUXs), which can withstand temperatures higher than normal payload electronics equipment.

The technology herein includes satellites wherein the east and west sides are thermally coupled together using thermal coupling heat pipes which are exposed to the environment, on the exterior of the satellites, and the east and west sides can thereby share the thermal load. By coupling the east and west panels together using exposed thermal coupling heat pipes, the thermal dissipation capability of the east and west radiator panels of the radiator system can be increased. In addition, the radiator system disclosed herein can accommodate an imbalance in payload thermal dissipation between east and west panels, thereby reducing required heater power. In an example of the technology, heat-generating components of a satellite are attached to multiple radiator panels which are attached to each of the north side 680, south side 681, east side 685, and west side 682.

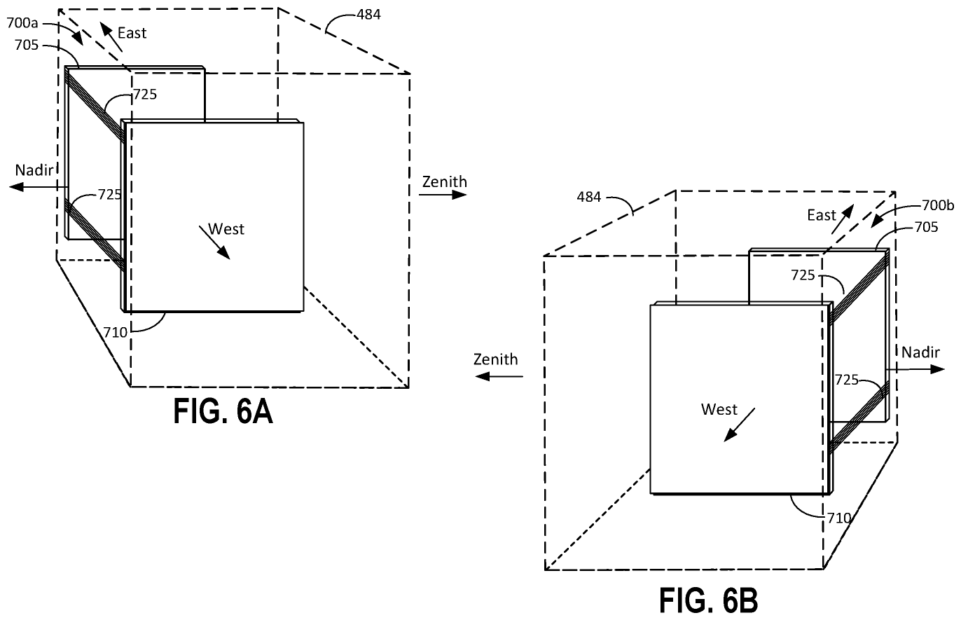

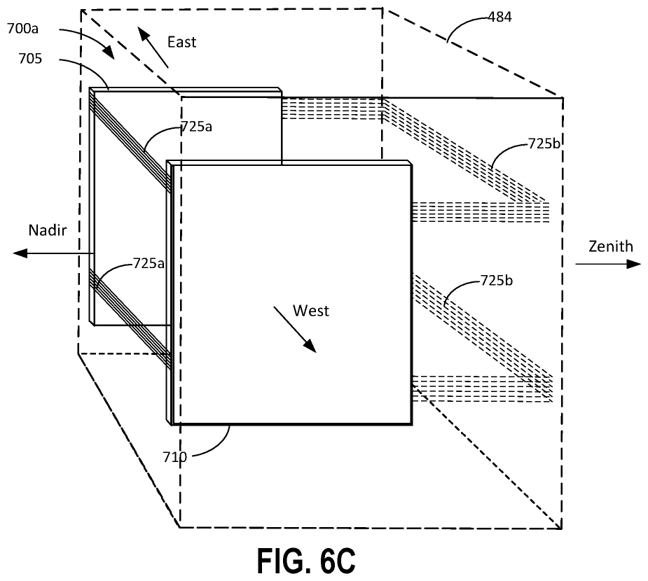

FIGS. 6A and 6B illustrate a first embodiment of a radiator system 700a and a second embodiment of a radiator system 700b, each comprising a pair of radiator panels—an east radiator panel 705 and a west radiator panel 710—configured to be attached to east facing side 685 and west facing side 682 of central body 464. The east radiator panel 705 and west radiator panel 710 each comprise one or more heat pipes. East radiator panel 705 is connected to the west radiator panel 710 by coupling heat pipes 725. Heat dissipating equipment may be mounted on each of the radiator panels. As described below, (and shown in FIGS. 6A and 6B) the coupling heat pipes 725 connecting the east/west radiator panels are exposed to space on the exterior of the central body 464. In system 700a, coupling heat pipes 725 are positioned at a surface 684 of the central body which is configured to align with an nadir direction to the orbital body when the central body is in orbit around the orbital body. In system 700b, the coupling heat pipes 725 are positioned at a surface 682 of the central body configured to align with a zenith direction relative to the orbital body when the central body is in orbit around the orbital body. Although the radiator panels 705, 710, (and other radiator panels herein) are illustrated as generally rectangular, it should be understood that the panels may take any number of shapes and the technology described herein is not limited to radiator panels of any particular shape. Each of coupling heat pipes 725, (and other coupling heat pipes described herein) may comprise one or more loop heat pipes comprising thin-walled tubing that connect the respective radiator panels.

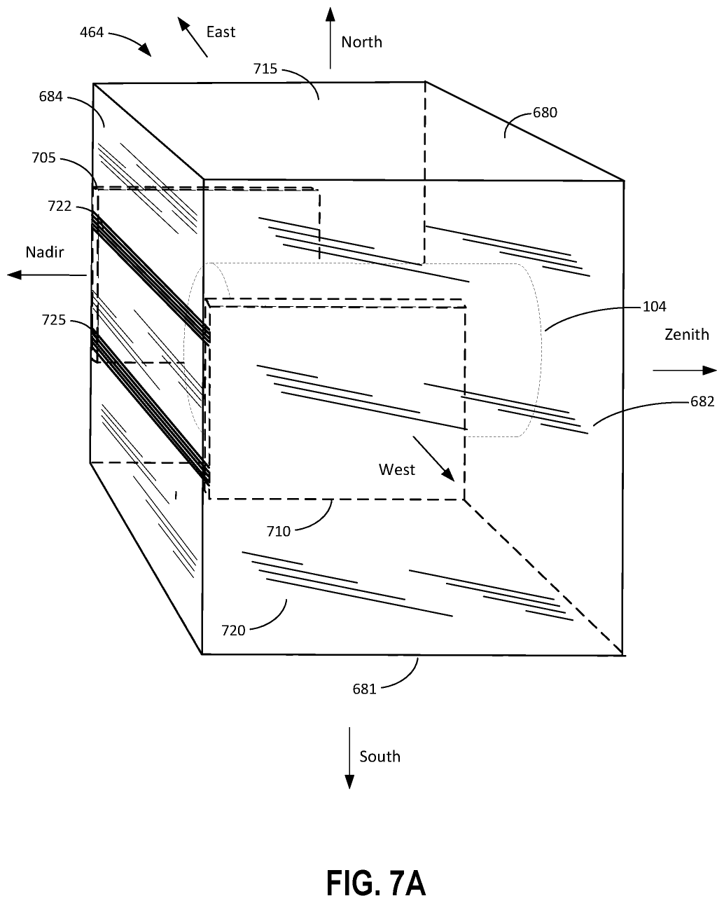

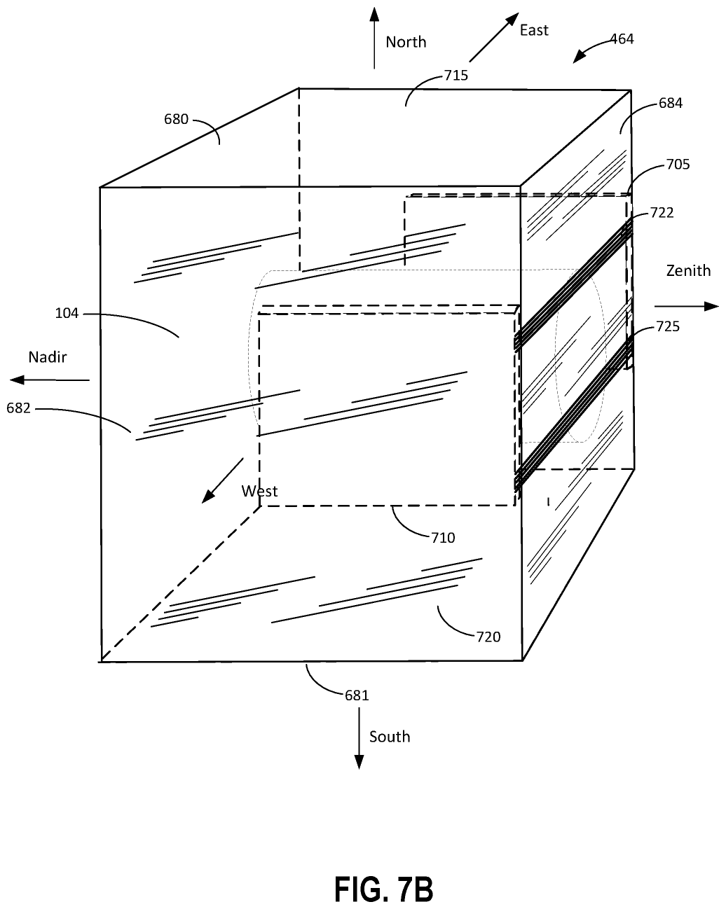

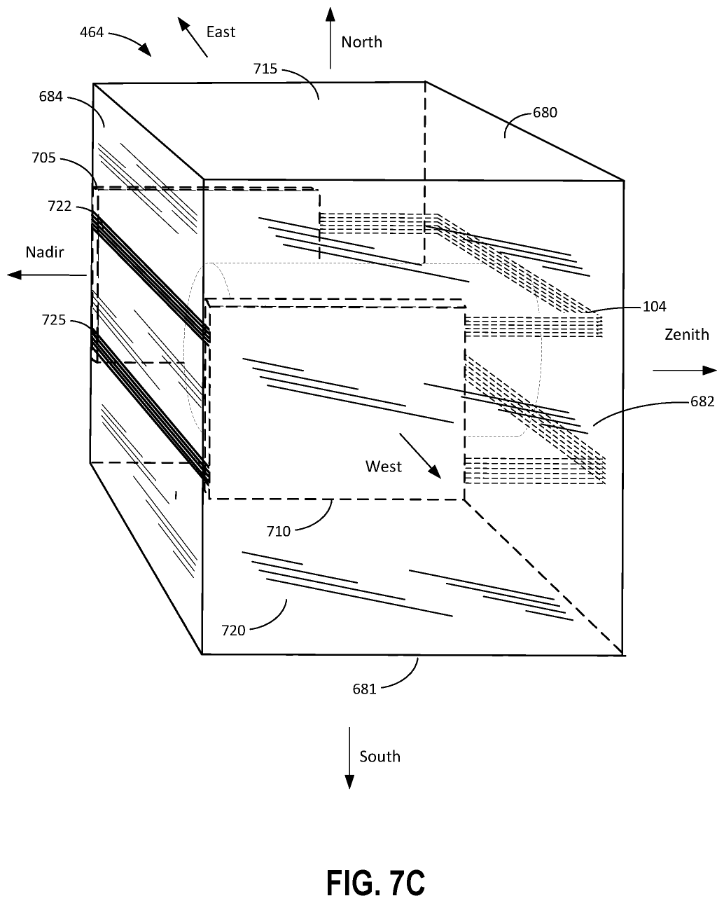

FIG. 6C illustrates another embodiment of a radiator system 700c comprising east radiator panel 705 and west radiator panel 710 coupled by coupling heat pipes 725a, 725b adjacent both the nadir and zenith surfaces of the central body, respectively. Heat pipes 725a are positioned at a surface 684 of the central body which is configured to align with an nadir direction to the orbital body when the central body is in orbit around the orbital body and coupling heat pipes 725b are positioned at a surface 682 of the central body configured to align with a zenith direction relative to the orbital body when the central body is in orbit around the orbital body. At least a portion of heat pipes 725a, 725b is exposed on the exterior of the central body as illustrated in FIG. 7C.

In one aspect, illustrated in FIGS. 7-10, coupling heat pipes 725 (and heat pipes 725a, 725b) connecting the east/west radiator panels have at least a portion exposed to space on the exterior of the central body 464. With reference to FIGS. 7A and 7B, in one example, coupling heat pipes 725 are provided on the exterior of the housing of the central body, and in particular on the exterior of the front, forward (nadir) side 684 of the central body 464. In one example, the coupling heat pipes 725 are thus exposed to radiate heat to the external environment. In a further example, the external portions of the heat pipes 725 (and any of the coupling heat pipes described herein) may be coated with a thermal control coating such white thermal control paint. A thermal control coating generally designed to allow only a fraction of any solar radiation impinging on the satellite's external surface to be absorbed through to the interior systems while emitting a larger percentage of the internal heat generated to the exterior environment of the central body exposed to space is suitable. FIG. 7C illustrates the embodiment of FIG. 6C wherein both coupling heat pipes 725a, 725b have a portion which is exposed to the exterior of the central body.

The east and west sides 685, 682 thus act in tandem to dissipate heat generated by the satellite. While each of the east side 685 and west side 682 has a length and in FIGS. 7-10 the coupling heat pipes 725 (and heat pipes 725a, 725b) are illustrated as being exposed to the exterior of the central body along the full length of each side 685, 682, it will be understood that the heat pipes 725 may be exposed along only a portion of the length of each side.

By coupling the east and west facing panels east and west radiator panels 705, 710 together in this manner, the east and west radiators 705, 710 increases the thermal dissipation capability of the east and west facing radiator panels 705, 710 and radiator systems 700a-700c as a whole, by increasing the ability to transfer heat from the east to west sides of the satellite 201. In addition, because the east and west radiator panels 705, 710 are coupled together, the radiator system 700 can accommodate an imbalance in payload thermal dissipation between the east and west panels 705, 710, thereby reducing required heater power.

A benefit of the technology is that the peak temperature experienced by the east and west panels 705, 710 over time during orbit is reduced without adding additional hardware. In space, east and west panels 705, 710 are exposed to an environment that varies widely in temperature as the satellite orbits around an orbital body. The technology smooths the peak temperature curve relative to previous systems.

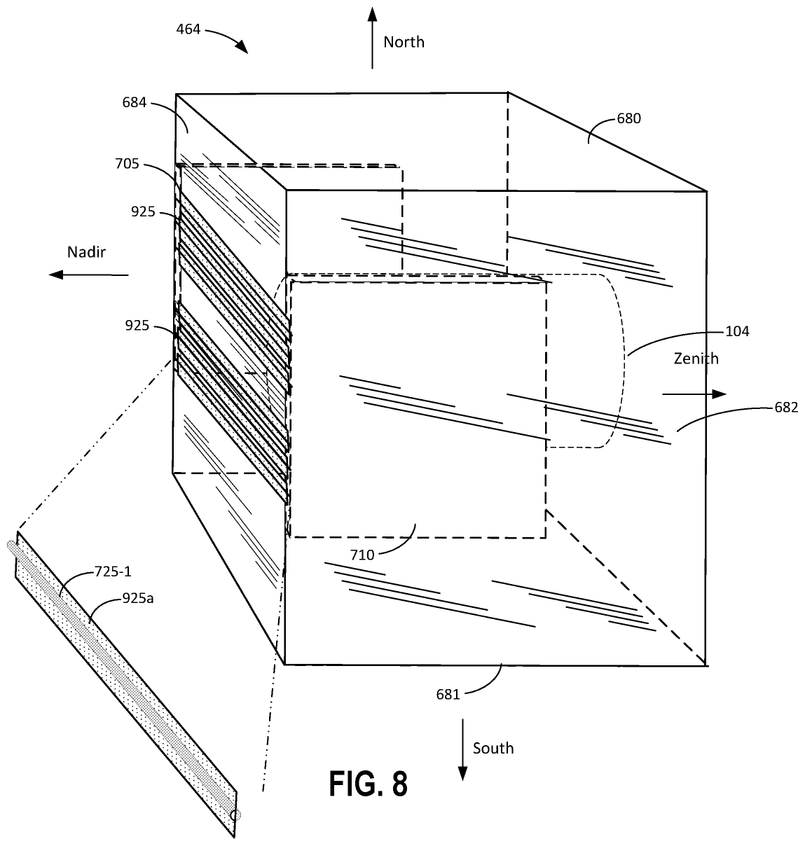

FIGS. 8-10 illustrate various thermal conductive structures which may be utilized with any of the coupling heat pipes disclosed herein. Although in FIGS. 8-10 the structures are illustrated with respect to conductive heat pipes sets 725, it will be understood that the structures may be used with any of sets of heat pipes 725a, 725b. In addition, although in FIGS. 6A-7C the coupling heat pipes are illustrated as relatively closely spaced, the spacing of the coupling heat pipes may be adjusted as necessary to accommodate various thermal characterizes and thermally conductive structures.

FIG. 8 illustrates on embodiment of the technology whereby a thermally conductive structure is attached to the coupling heat pipes 725. In this example, the thermally conductive structure comprises a plurality of fins 925 which are thermally attached to the coupling heat pipes 725 on the exterior of the central body. As illustrated in the exploded portion of FIG. 8, each fin 925a is generally rectangular and constructed of a thermally conductive metal, having a planar surface which lies parallel to the planar surface of side 684 and is bisected by a portion 725-1 of a coupling heat pipe. Although the fins 925 are illustrated as being generally rectangular and having a planar surface, the thermal conductive structure may take any planar shape and in other examples need not be planar. In this example, the fins are attached to the coupling heat pipes 725, which are themselves exposed to space on the exterior of the central body 464. The planar surface of each fin is oriented parallel to the surface 684. Any number of fins may be provided and the spacing of the coupling heat pipes 725 adapted to accommodate both the size and number of fins. While the fins are shown as provided along the entire length of the exterior surface of forward (nadir) 684, the fins may be provided on only a portion of the entire length of the exterior surface of forward (nadir) 684.

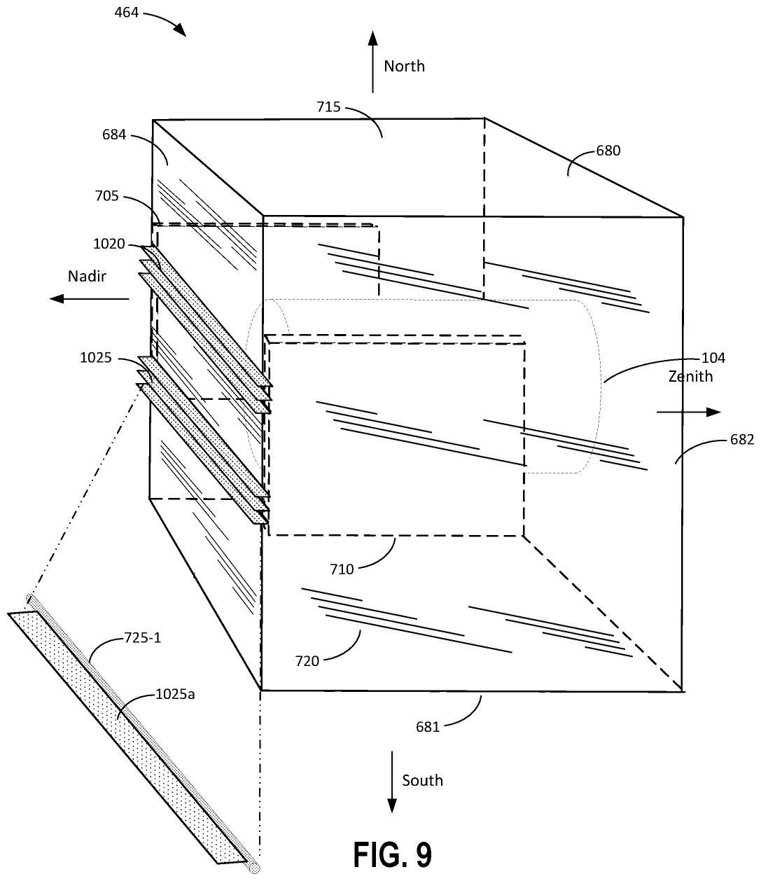

FIG. 9 illustrates another embodiment of the technology whereby a different thermally conductive structure comprising a plurality of fins 1025 is illustrated. The fins 1025 are thermally attached to the coupling heat pipes 725 on the exterior of the central body. In this example, the fins are generally rectangular and have a planar surface with the planar surface running perpendicular to the length of the forward (nadir) 684 and may take any planar shape and in other examples need not be planar nor rectangular. In this example, the fins are attached to the coupling heat pipes 725, which are themselves exposed to space on the exterior of the central body 464. As illustrated in the exploded portion of FIG. 9, each fin 1025a is generally rectangular and constructed of a thermally conductive metal, with a planar surface which lies perpendicular to the planar surface of side 684 and thermally coupled to portion 725-1 of a coupling heat pipe. Any number of fins may be provided. While the fins 1025 are shown as provided along the entire length of the exterior surface of forward (nadir) 684, the fins may be provided on only a portion of the entire length of the exterior surface of forward (nadir) 684.

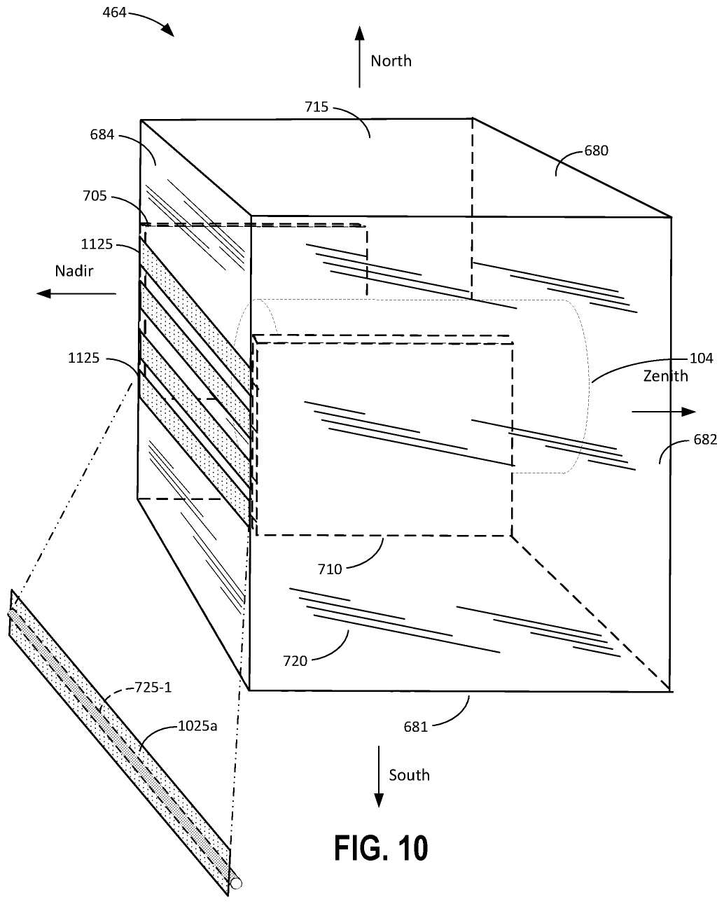

FIG. 10 illustrates another embodiment of the technology whereby a different thermally conductive structure comprising a plurality of fins 1125 is illustrated. The fins 1125 are thermally attached to the coupling heat pipes 725 on the exterior of the central body. Similar to the embodiment of FIG. 8, the fins 1125 have a planar surface which is parallel to the surface of side 684. As illustrated in the exploded portion of FIG. 10, each fin 1125a is generally rectangular and constructed of a thermally conductive metal, with a planar surface which lies parallel to the planar surface of side 684 and thermally coupled to one side of portion 725-1 of a coupling heat pipe.

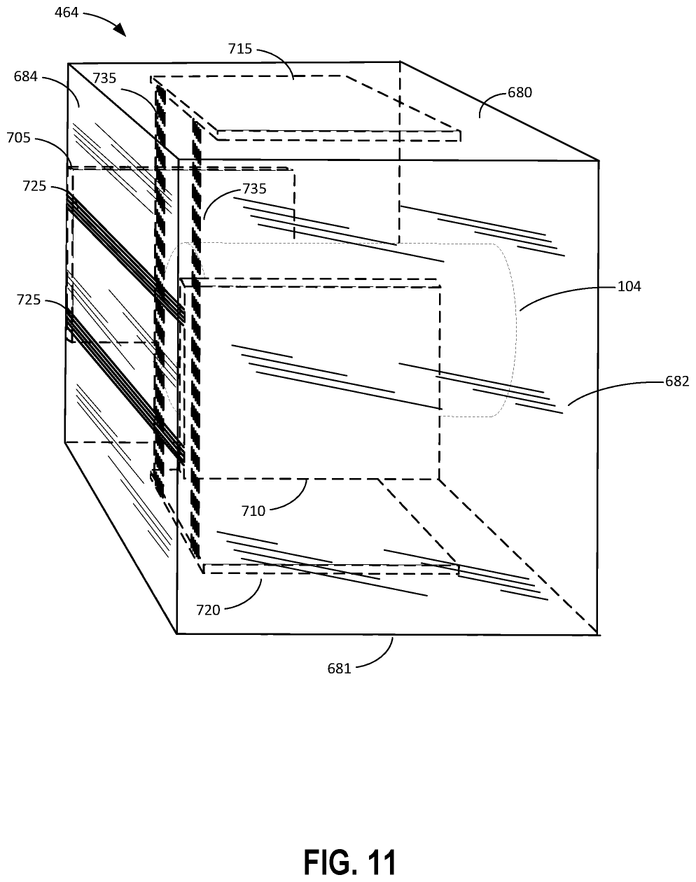

FIG. 11 illustrates another embodiment of a radiator system 1200 comprising two pairs of radiator panels (such as panel 506) for a satellite 201. Two additional. radiator panels 715 and 720 are configured to be attached to north facing side 680 and south facing side 681, respectively, of central body 464. The north radiator panel 715 and south radiator panel 720 each comprise one or more heat pipes. North radiator panel 715 is connected to the south radiator panel 720 by coupling heat pipes 730, 735.

As illustrated in FIG. 11, the respective north/south radiator panels and east/west radiator panels may be constructed such that opposing edges of the east/west radiators are adjacent to opposing edges of the north south radiators, and the coupling heat pipes are positioned closer to the forward (nadir) side 684 of the central body 464. In embodiments, the east radiator panel 705 and west radiator panel 710 are connected to the coupling heat pipes 725 in an east/west assembly and, in the embodiment of FIG. 11 the north radiator panel 715 and south radiator panel 720 are connected to the coupling heat pipes 735 in a north/south assembly. In FIG. 11, the opposing edges of the east/west radiators are adjacent to opposing edges of the north south radiators.

In one embodiment, a satellite comprising a first radiator panel on a first side of a central body of the satellite and a second radiator panel on a second side of the central body is provided. The first radiator panel is thermally attached to the second radiator panel. A third side of the central body is positioned between the first side and the second side. A fourth side of the central body is positioned between the first side and the second side, opposing the third side. The first radiator panel is thermally attached to the second radiator panel by one or more coupling heat pipes, the coupling heat pipes exposed to an exterior environment of the satellite.

The satellite may be configured to orbit an orbital body such that the first side and the second side are aligned in an east direction and a west direction, respectively, relative to the orbital body. The satellite may be configured to orbit an orbital body such that the third side and fourth side are aligned in an north direction and a south direction, respectively, relative to the orbital body. In another example, the satellite of any of the previous examples is configured to align the first side in an east direction and the second side in a west direction relative to the orbital body, and the coupling heat pipes are exposed on the third side in a nadir direction relative to the orbital body, or the fourth side in a zenith direction relative to the orbital body, or both the coupling heat pipes are exposed on the third side in a nadir direction relative to the orbital body and on the fourth side in a zenith direction relative to the orbital body. In other embodiment, any of the previous embodiments may include a satellite wherein the coupling heat pipes are coated with a thermal control coating. The satellite of any of the previous examples may further include a thermally conductive structure attached to the coupling heat pipes and exposed to the exterior environment. The thermally conductive structure may include one or more thermally conductive fins. Another embodiment may include a satellite further including a third radiator panel on a fifth side of a central body of the satellite; a fourth radiator panel a sixth side of the central body, the third radiator panel generally spaced apart from the fourth radiator panel and thermally attached to the third radiator panel by one or more coupling heat pipes, wherein the fifth side configured to align with a north direction of the orbital body and the sixth side configured to align with a south direction of the orbital body.

Another example disclosed herein includes an apparatus having a central body. The apparatus includes a first radiator positioned at a first surface of the central body, the first surface of the central body configured to align with an east direction of an orbital body when the central body is in orbit around the orbital body. The apparatus also includes a second radiator positioned at a second surface of the central body, the second surface of the central body configured to align with a west direction of an orbital body when the central body is in orbit around the orbital body. The apparatus further includes a third surface of the central body, the third surface of the central body configured to align with an nadir direction to the orbital body when the central body is in orbit around the orbital body. The apparatus also includes a fourth surface of the central body, the fourth surface of the central body configured to align with a zenith direction relative to the orbital body when the central body is in orbit around the orbital body. The first radiator is thermally connected to the second radiator by a coupling heat pipe, at least a portion of which is exposed to an exterior of the central body.

The apparatus may include a coupling heat pipe is coated with a thermal control coating. The apparatus of any of the previous examples may further include a thermally conductive structure attached to the coupling heat pipe and exposed to an exterior of the central body. The thermally conductive structure may comprise one or more thermally conductive fins. The apparatus of any of the previous examples may further include an apparatus where coupling heat pipe is exposed to an exterior surface of the third surface side of the central body or the fourth surface of the central body.

One general aspect includes a satellite including a central body. The satellite also includes a first radiator on a first side of the central body of the satellite, with the first side of the central body configured to align with an east direction of an orbital body when the central body is in orbit around the orbital body. The satellite also includes a second radiator on a second side of the central body, the second side of the central body is configured to align with a west direction of an orbital body when the central body is in orbit around the orbital body. The first radiator is thermally attached to the second radiator. The satellite also includes a third side of the central body, the third side of the central body configured to align with an nadir direction of the orbital body when the central body is in orbit around the orbital body. The satellite also includes a fourth side of the central body, the fourth side of the central body being configured to align with a zenith direction relative to the orbital body when the central body is in orbit around the orbital body.

Implementations may include a satellite where the coupling heat pipe is coated with a thermal control coating, a satellite further including a thermally conductive structure attached to the coupling heat pipes and exposed to the exterior environment, and/or a thermally conductive structure may include one or more thermally conductive fins.

For purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate thermally between them.

For purposes of this document, the term “based on” may be read as “based at least in part on.”

For purposes of this document, without additional context, use of numerical terms such as a “first” object, a “second” object, and a “third” object may not imply an ordering of objects but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit the subject matter claimed herein to the precise form(s) disclosed. Many modifications and variations are possible in light of the above teachings. The described embodiments were chosen in order to best explain the principles of the disclosed technology and its practical application to thereby enable others skilled in the art to best utilize the technology in various embodiments and with various modifications as are suited to the particular use contemplated. It is intended that the scope of be defined by the claims appended hereto.

What is claimed is:

1. A satellite comprising:
a first radiator panel on a first side of a central body of the satellite
a second radiator panel on a second side of the central body, the first radiator panel generally spaced apart from the second radiator panel and thermally attached to the second radiator panel;
a third side of the central body, the third side positioned between the first side and the second side; and
a fourth side of the central body, the fourth side positioned between the first side and the second side, opposing the third side, the first radiator panel thermally attached to the second radiator panel by one or more coupling heat pipes, the coupling heat pipes exposed to an exterior environment of the satellite.

2. The satellite of claim 1 wherein the satellite is configured to orbit an orbital body such that the first side and the second side are aligned in an east direction and a west direction, respectively, relative to the orbital body.

3. The satellite of claim 1 wherein the satellite is configured to align the first side in an east direction and the second side in a west direction relative to the orbital body, and the coupling heat pipes are exposed on the third side in a nadir direction relative to the orbital body.

4. The satellite of claim 1 wherein the satellite is configured to align the first side in an east direction and the second side in a west direction relative to the orbital body, and the coupling heat pipes are exposed on the fourth side in a zenith direction relative to the orbital body.

5. The satellite of claim 1 wherein the satellite is configured to align the first side in an east direction and the second side in a west direction relative to the orbital body, and the coupling heat pipes are exposed on the third side in a nadir direction relative to the orbital body and on the fourth side in a zenith direction relative to the orbital body.

6. The satellite of claim 1 wherein the coupling heat pipes are coated with a thermal control coating.

7. The satellite of claim 2 further including a thermally conductive structure attached to the coupling heat pipes and exposed to the exterior environment.

8. The satellite of claim 8 wherein the thermally conductive structure comprises one or more thermally conductive fins.

9. The satellite of claim 1 wherein each side has a length, and the coupling heat pipes extend along the length of each said side.

10. The satellite of claim 1 further including
a third radiator panel on a fifth side of a central body of the satellite
a fourth radiator panel a sixth side of the central body, the third radiator panel generally spaced apart from the fourth radiator panel and thermally attached to the third radiator panel by one or more coupling heat pipes, the fifth side configured to align with a north direction of the orbital body and the sixth side configured to align with a south direction of the orbital body.

11. An apparatus comprising:
a central body;
a first radiator positioned at a first surface of the central body, the first surface of the central body configured to align with an east direction of an orbital body when the central body is in orbit around the orbital body;
a second radiator positioned at a second surface of the central body, the second surface of the central body configured to align with a west direction of the orbital body when the central body is in orbit around the orbital body;
a third surface of the central body, the third surface of the central body configured to align with an nadir direction to the orbital body when the central body is in orbit around the orbital body;
a fourth surface of the central body, the fourth surface of the central body configured to align with a zenith direction relative to the orbital body when the central body is in orbit around the orbital body; and
the first radiator is thermally connected to the second radiator by a coupling heat pipe at least a portion of which is exposed to an exterior of the central body during a period of exposure from the sun on at least the third or fourth sides.

12. The apparatus of claim 11 wherein the coupling heat pipe is coated with a thermal control coating.

13. The apparatus of claim 11 further including a thermally conductive structure attached to the coupling heat pipe and exposed to an exterior of the central body.

14. The apparatus of claim 13 wherein the thermally conductive structure comprises one or more thermally conductive fins.

15. The apparatus of claim 13 wherein the coupling heat pipe is exposed to an exterior surface the third surface or the fourth surface.

16. The apparatus of claim 13 wherein the coupling heat pipe is exposed to an exterior surface of both the third surface and the fourth surface.

17. A satellite including a central body, the central body comprising:
a first radiator on a first side of the central body of the satellite, the first side of the central body configured to align with an east direction of an orbital body when the central body is in orbit around the orbital body;
a second radiator on a second side of the central body, the second side of the central body configured to align with a west direction of the orbital body when the central body is in orbit around the orbital body, the first radiator thermally attached to the second radiator;
a third side of the central body, the third side of the central body configured to align with a nadir direction to the orbital body when the central body is in orbit around the orbital body;
a fourth side of the central body, the fourth side of the central body configured to align with a zenith direction of the orbital body when the central body is in orbit around the orbital body, the first radiator thermally attached to the second radiator by one or more coupling heat pipes, the coupling heat pipes exposed to an exterior environment on a third or fourth side of the central body.

18. The satellite of claim 17 wherein the coupling heat pipe is coated with a thermal control coating.

19. The satellite of claim 18 further including a thermally conductive structure attached to the coupling heat pipes and exposed to the exterior environment.

20. The satellite of claim 19 wherein the thermally conductive structure comprises one or more thermally conductive fins.
